(19) United States
(12) Patent Application Publication
(10) Pub. No.: US 2025/0154360 A1
(43) Pub. Date: May 15, 2025

(54) METHODS AND SYSTEMS FOR USING SILICON-CONTAINING ADDITIVES TO PRODUCE CARBON PARTICLES

(71) Applicant: Monolith Materials, Inc., Lincoln, NE (US)

(72) Inventors: Enoch E. Dames, Lincoln, NE (US); Elliott T. Wyse, Lincoln, NE (US); Michael Frenklach, Lincoln, NE (US); Christopher Mesrobian, Lincoln, NE (US)

(21) Appl. No.: 18/770,339

(22) Filed: Jul. 11, 2024

Related U.S. Application Data
(63) Continuation of application No. PCT/US2023/010695, filed on Jan. 12, 2023.
(60) Provisional application No. 63/298,912, filed on Jan. 12, 2022.
(60) Provisional application No. 63/350,801, filed on Jun. 9, 2022.

(51) Int. Cl. C09C 1/48; C09C 1/28; C09C 3/06

(52) U.S. Cl. CPC C09C 1/485; C09C 1/28; C09C 3/063; C01P 2004/64; C01P 2004/80; C01P 2006/12

(57) ABSTRACT

The present disclosure provides methods and systems for improving a yield of carbon particles from a carbon particle generating rector. The methods and systems may comprise use of a silicon-containing additive in the carbon particle generating process.

### CROSS-REFERENCE

This application a continuation of International Application No. PCT/US2023/010695, filed Jan. 12, 2023, which claims the benefit of U.S. Provisional Application Nos. 63/298,912, filed Jan. 12, 2022, and 63/350,801, filed Jun. 9, 2022, each of which is incorporated herein by reference in its entirety.

### BACKGROUND

Carbonaceous materials or hydrogen may be produced by various chemical processes. Performance, energy supply and environmental performance associated with such chemical processes has evolved over time.

### SUMMARY

A method for generating a carbon particle comprising: (a) providing a silicon-containing additive and a carbonaceous material to a reactor, wherein the silicon-containing additive is provided to the reactor at a ratio of the silicon-containing additive to the carbonaceous material, and wherein the ratio is less than or equal to about 0.1 by weight; and (b) in the reactor, contacting the carbonaceous material with the silicon-containing additive to generate the carbon particle.

In some embodiments, the carbon particle comprises at least one silicon core decorated with carbon. In some embodiments, in (a), the ratio of the silicon-containing additive to the carbonaceous material is less than or equal to about 0.01 by weight. In some embodiments, in (a), the ratio of the silicon-containing additive to the carbonaceous material is less than or equal to about 0.001 by weight. In some embodiments, (b) comprises reacting the carbonaceous material with the silicon-containing additive to generate a plurality of carbon particles. In some embodiments, after (b), less than or equal to about 5% by weight of the carbonaceous material is present in the reactor as wall fouling. In some embodiments, a ratio of the silicon-containing additive to the carbonaceous material within the carbon particles is substantially the same as a ratio of the silicon-containing additive to the carbonaceous material within wall fouling of the reactor. In some embodiments, more than about 90% of the carbonaceous material is converted into the carbon particles on a weight percent carbon basis. In some embodiments, (b) comprises (i) heating a thermal transfer gas and (ii) contacting the thermal transfer gas with the carbonaceous material and the silicon-containing additive to generate the carbon particle. In some embodiments, the silicon-containing additive comprises one or more of a siloxane, a polysiloxane, a silane, and a silica. In some embodiments, the silicon-containing additive comprises the siloxane, and the siloxane is hexamethyldisiloxane (HMDSO) or decamethylcyclopentasiloxane (D5). In some embodiments, the silicon-containing additive comprises one or more particles. In some embodiments, the silicon-containing additive comprises one or more nanoparticles. In some embodiments, the carbonaceous material comprises at least about 70% by weight of methane, ethane, propane, or a combination thereof. In some embodiments, the carbonaceous material comprises one or more linear hydrocarbon(s), one or more aromatic hydrocarbon(s), one or more unsaturated hydrocarbon(s), one or more oxygenated hydrocarbon(s), or any combination thereof. In some embodiments, the carbonaceous material comprises methane, ethane, propane, butane, benzene, toluene, xylene, methyl naphthalene, naphthalene, pyrolysis fuel oil, coal tar, coal, heavy oil, oil, bio-oil, bio-diesel, other biologically derived hydrocarbons, ethylene, acetylene, butadiene, styrene, ethanol, methanol, propanol, phenol, ketones, ethers, esters, or any combination thereof. In some embodiments, the method further comprises reacting the carbonaceous material with the silicon-containing additive in a presence of a plasma. In some embodiments, the generating of the carbon particle is performed at a rate of at least about 600 kilograms/hour (kg/h) of carbon particle production. In some embodiments, an energy used to produce the carbon particle is reduced by at least about 5% as compared to a method without addition of the silicon-containing additive.

A method for generating a carbon particle comprising: (a) providing a silicon-containing additive and a carbonaceous material to a reactor; and (b) in the reactor, decomposing the carbonaceous material to form the carbon particle in a presence of a plasma and the silicon-containing additive.

In some embodiments, the decomposing is performed at a temperature less than or equal to about 2100° C. In some embodiments, the decomposing is performed at a temperature less than or equal to about 1900° C. In some embodiments, the decomposing is performed at a temperature less than or equal to about 1700° C. In some embodiments, the decomposing is performed at a temperature from about 1500° C. to 2100° C. In some embodiments, the decomposing is performed at a temperature from about 1550° C. to 1850° C. In some embodiments, the decomposing is performed at a temperature from about 1600° C. to 1750° C. In some embodiments, the temperature is at least about 50 degrees Celsius lower than a temperature of a method without the silicon-containing additive. In some embodiments, the temperature is a calculated temperature. In some embodiments, (a) comprises providing the silicon-containing additive in a thermal transfer gas. In some embodiments, the thermal transfer gas comprises at least about 60% hydrogen. In some embodiments, (a) comprises providing the silicon-containing additive in a material stream comprising the carbonaceous material. In some embodiments, the silicon-containing additive comprises one or more of a siloxane, a polysiloxane, a silane, and a silica. In some embodiments, the silicon-containing additive comprises the siloxane, and the siloxane is hexamethyldisiloxane (HMDSO) or decamethylcyclopentasiloxane (D5). In some embodiments, the silicon-containing additive comprises one or more particles. In some embodiments, the silicon-containing additive comprises one or more nanoparticles. In some embodiments, the carbonaceous material comprises at least about 70% by weight of methane, ethane, propane, or mixtures thereof. In some embodiments, the carbonaceous material comprises one or more simple hydrocarbons, one or more aromatic hydrocarbons, one or more unsaturated hydrocarbons, one or more oxygenated hydrocarbons, or any combination thereof. In some embodiments, the carbonaceous material comprises methane, ethane, propane, butane, benzene, toluene, xylene, methyl naphthalene, pyrolysis fuel oil, coal tar, coal, heavy oil, oil, bio-oil, bio-diesel, other biologically derived hydrocarbons, ethylene, acetylene, butadiene, styrene, ethanol, methanol, propanol, phenol, ketones, ethers, esters, or any combination thereof. In some embodiments, (b) comprises decomposing the carbonaceous material in the presence of the plasma and the silicon-containing additive to generate a plurality of carbon particles. In some embodiments, less than or equal to about 5% by weight of the carbonaceous material is present in the reactor as wall fouling in the reactor. In some embodiments, a ratio of the silicon-containing additive to the carbonaceous material within the carbon particles is substantially the same as a ratio of the silicon-containing additive to the carbonaceous material within wall fouling of the reactor.

A method for generating a carbon particle comprising: (a) providing a silicon-containing additive and a carbonaceous material to a reactor; (b) in the reactor, reacting the carbonaceous material and the silicon-containing additive to generate a nucleate, wherein the nucleate comprises at least one silicon core; and (c) growing the carbon particle on the nucleate. In some embodiments, in (a), the ratio of silicon-containing additive to the carbonaceous material is less than or equal to about 0.1 by weight. In some embodiments, in (a), the ratio of silicon-containing additive to the carbonaceous material is less than or equal to about 0.01 by weight. In some embodiments, in (a), the ratio of silicon-containing additive to the carbonaceous material is less than or equal to about 0.001 by weight. In some embodiments, (c) further comprises growing a plurality of carbon particles on the nucleate. In some embodiments, the silicon-containing additive comprises one or more of a siloxane, a polysiloxane, a silane, and a silica. In some embodiments, the silicon-containing additive comprises the siloxane, and the siloxane is hexamethyldisiloxane (HMDSO) or decamethylcyclopentasiloxane (D5). In some embodiments, the silicon-containing additive comprises one or more particles. In some embodiments, the silicon-containing additive comprises one or more nanoparticles. In some embodiments, the carbonaceous material comprises at least about 70% by weight of methane, ethane, propane, or mixtures thereof. In some embodiments, the carbonaceous material comprises one or more simple hydrocarbons, one or more aromatic feedstocks, one or more unsaturated hydrocarbons, one or more oxygenated hydrocarbons, or any combination thereof. In some embodiments, the carbonaceous material comprises methane, ethane, propane, butane, benzene, toluene, xylene, methyl naphthalene, pyrolysis fuel oil, coal tar, coal, heavy oil, oil, bio-oil, bio-diesel, other biologically derived hydrocarbons, ethylene, acetylene, butadiene, styrene, ethanol, methanol, propanol, phenol, ketones, ethers, esters, or any combination thereof. In some embodiments, (b) comprises generating a plurality of nucleates comprising silicon cores and (c) comprises growing a plurality of carbon particles on the plurality of nucleates. In some embodiments, less than or equal to about 5% by weight of the carbonaceous material is present in the reactor as wall fouling in the reactor. In some embodiments, a ratio of the silicon-containing additive to the carbonaceous material within the carbon particles is substantially the same as a ratio of the silicon-containing additive to the carbonaceous material within wall fouling of the reactor. In some embodiments, (b) is performed in a presence of a plasma. In some embodiments, (c) is performed in a presence of a plasma.

Applicant has realized a variety of benefits of the methods and systems of the present disclosure. For example, use of a silicon-containing additive can reduce the temperature of a reactor used to generate carbon particles. The reduced temperature can result in a variety of benefits such as, for example, decreased reactor or electrode wear, increased run times, improved reactor up time and efficiency, etc. These benefits can be realized without substantial changes in the properties of the carbon particles. For example, the carbon particles can maintain their surface area and density while the processes used to generate the particles can be performed at a lower temperature.

In another aspect, the present disclosure provides a carbon particle comprising a structure, wherein an ash comprising the structure produced from the carbon particle via ASTM D1506 has a surface area of at least about 100 square meters per gram (m²/g).

In some embodiments, the structure produces the surface area. In some embodiments, the carbon particle is carbon black. In some embodiments, the structure comprises silicon.

In another aspect, the present disclosure provides a carbon containing particle comprising a non-carbon portion, wherein the non-carbon portion has a surface area of at least about 100 square meters per gram (m²/g).

In some embodiments, the non-carbon portion comprises silicon. In some embodiments, the non-carbon portion comprises at least about 50% silicon. In some embodiments, the surface area of the non-carbon portion is determined via ashing by ASTM D1506. In some embodiments, the carbon containing particle is carbon black. In some embodiments, the non-carbon portion comprises at most about 15 percent of the weight of the carbon particle. In some embodiments, the carbon particle has a lattice constant (L_{c}) of at least about 3 nanometers.

In another aspect, the present disclosure provides a carbon particle comprising a structure, wherein an ash comprising the structure produced from the carbon particle via ASTM D1506 comprises a pour density of at most about 100 kilograms per cubic meter (kg/m³).

In some embodiments, the structure produces the surface area. In some embodiments, the carbon particle is carbon black. In some embodiments, the structure comprises silicon.

In another aspect, the present disclosure provides a carbon containing particle comprising a non-carbon portion, wherein the non-carbon portion comprises a pour density of at most about 100 kilograms per cubic meter (kg/m³).

In some embodiments, the non-carbon portion comprises silicon. In some embodiments, the non-carbon portion comprises at least about 50% silicon. In some embodiments, the surface area of the non-carbon portion is determined via ashing by ASTM D1506. In some embodiments, the carbon containing particle is carbon black. In some embodiments, the non-carbon portion comprises at most about 15 percent of the weight of the carbon particle. In some embodiments, the carbon particle has a lattice constant (L_{c}) of at least about 3 nanometers. In some embodiments the method is performed in an environment substantially free of oxygen. In some embodiments, the method is performed in an environment free of detectable oxygen.

Another aspect of the present disclosure provides a system comprising one or more computer processors and computer memory coupled thereto. The computer memory comprises machine executable code that, upon execution by the one or more computer processors, implements any of the methods above or elsewhere herein.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure.

Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “Figure” and “FIG.” herein), of which:

FIG. 1 is a flowchart of an example method for generating a carbon particle, according to some embodiments.

FIG. 2 is a flowchart of an example method for generating a carbon particle, according to some embodiments.

FIG. 3 is a flowchart of an example method for generating a carbon particle, according to some embodiments.

FIG. 4 is an example plot of a residual amount of methane present in a gas output of a reactor, according to some embodiments.

FIG. 5 is an example plot of a yield of solid carbon (e.g., carbon particles) from a reactor without and with addition of a silicon-containing additive, according to some embodiments.

FIG. 6 shows an example of a comparison plot between the products of a carbon particle generating reaction with and without addition of a silicon containing additive, according to some embodiments.

FIG. 7 shows a computer system that is programmed or otherwise configured to implement methods provided herein.

FIG. 8 shows an array of conditions for an example large and small scale reactor, according to some embodiments.

FIG. 9 shows an example of a plasma reactor, according to some embodiments.

FIG. 10 provides an example of carbon particle production with and without a silicon-containing additive, according to some embodiments.

FIG. 11 shows an example of an additive addition scheme, according to some embodiments.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

Whenever the term “at least,” “greater than,” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Whenever the term “no more than,” “less than,” or “less than or equal to” precedes the first numerical value in a series of two or more numerical values, the term “no more than,” “less than,” or “less than or equal to” applies to each of the numerical values in that series of numerical values. For example, less than or equal to 3, 2, or 1 is equivalent to less than or equal to 3, less than or equal to 2, or less than or equal to 1.

Certain inventive embodiments herein contemplate numerical ranges. When ranges are present, the ranges include the range endpoints. Additionally, every sub range and value within the range is present as if explicitly written out. The term “about” or “approximately” may mean within an acceptable error range for the particular value, which will depend in part on how the value is measured or determined, e.g., the limitations of the measurement system. For example, “about” may mean within 1 or more than 1 standard deviation, per the practice in the art. Alternatively, “about” may mean a range of up to 20%, up to 10%, up to 5%, or up to 1% of a given value. Where particular values are described in the application and claims, unless otherwise stated the term “about” meaning within an acceptable error range for the particular value may be assumed.

As used herein, the term “carbon particle” may refer to a particle comprising carbon. Examples of carbon particles include, but are not limited to, carbon black, coke, needle coke, graphite, large ring polycyclic aromatic hydrocarbons, activated carbon, or the like, or any combination thereof. Carbon particles may be classified into grades. The carbon particles of the present disclosure may be of any grade.

Though described herein with respect to a silicon-containing additive, the methods and systems of the present disclosure can also be used with a derivative of the silicon-containing additive. As such, the terms silicon-containing additive and a derivative thereof may be interchangeable. For example, a silicon-containing additive can decompose to a radical derivative, and the radical derivative can react with a carbonaceous material. In this example, the silicon-containing additive may decompose at a faster rate than the carbonaceous material, and therefore the carbonaceous material can react with the decomposition derivative of the silicon-containing additive. The derivative may comprise a silicon or silicon oxide radical.

The methods and systems of the present disclosure may be performed in oxygen free environments. For example, the amount of oxygen in a reactor of the present disclosure may be below a detection limit of a detector. In some cases, the methods and systems of the present disclosure may be performed in a substantially oxygen free environment. For example, the environment may have a trace amount of oxygen (e.g., less than about 5, 4, 3, 2, 1, 0.5, 0.1, 0.05, 0.01, 0.005, 0.001, 0.0005, 0.0001, or less percent by mol oxygen). The oxygen may be present as diatomic oxygen, oxygen radicals, carbon monoxide, carbon dioxide, or the like, or any combination thereof. The methods and systems of the present disclosure may convert carbonaceous materials via pyrolysis (e.g., a breakdown of hydrocarbons to form polycyclic aromatic rings of carbon that can then nucleate and precipitate from the gas phase to form solid particles). The pyrolysis conversion may not make use of oxygen (e.g., oxygen may not be a reagent in the pyrolytic decomposition of carbonaceous materials).

In another aspect, the present disclosure provides a method for generating a carbon particle. A silicon-containing additive and a carbonaceous material can be provided to a reactor. The silicon-containing additive may be provided to the reactor at a ratio of the silicon-containing additive to the carbonaceous material. The ratio may be less than or equal to about 0.1 by weight. In the reactor, the carbonaceous material and the silicon-containing additive can be reacted to generate the carbon particle.

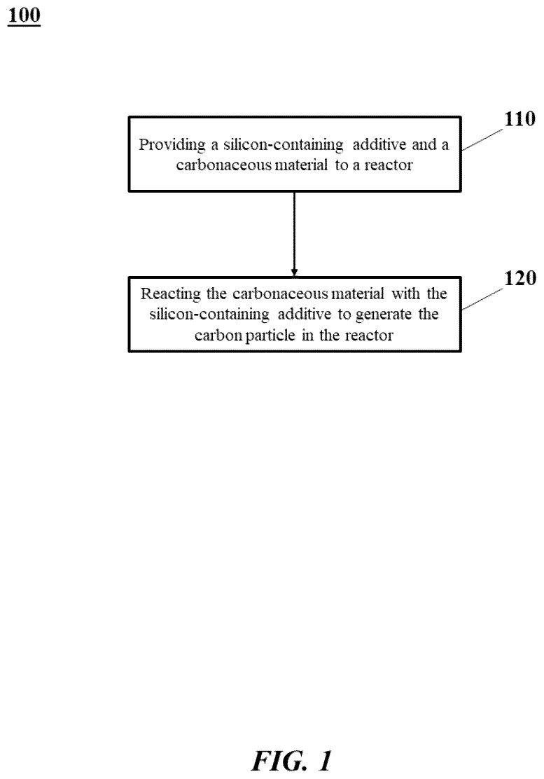

FIG. 1 is a flowchart of an example method 100 for generating a carbon particle, according to some embodiments. In an operation 110, the method 100 may comprise providing a silicon-containing additive and a carbonaceous material to a reactor. The silicon-containing additive can be provided to the reactor at a ratio. The ratio may be at least about 0.000001, 0.000005, 0.00001, 0.00005, 0.0001, 0.0002, 0.0003, 0.0004, 0.0005, 0.0006, 0.0007, 0.0008, 0.0009, 0.001, 0.0015, 0.002, 0.003, 0.004, 0.005, 0.01, 0.05, 0.1, 0.5, 1, or more by weight. The ratio may be at most about 1, 0.5, 0.1, 0.05, 0.01, 0.005, 0.004, 0.003, 0.002, 0.0015, 0.001, 0.0009, 0.0008, 0.0007, 0.0006, 0.0005, 0.0004, 0.0003, 0.0002, 0.0001, 0.00005, 0.00001, 0.000005, 0.000001, or less by weight. The ratio may be of a range as defined by any two of the preceding values. For example, the ratio may be from about 0.0002 to about 0.1 by weight. In another example, the ratio may be from about 0.0004 to about 0.0015.

The silicon-containing additive may comprise a siloxane. The siloxane may comprise a bonding scheme of silicon-oxygen-silicon. For example, the siloxane may comprise a pair of silicon atoms connected by a single oxygen atom. The siloxane may comprise additional functional groups bound to the silicon atoms. Examples of functional groups include, but are not limited to, alkanes, alkenes, alkynes, other hydrocarbons (e.g., aromatic rings, etc.), alcohols, thiols, amines, ethers, carboxylic acids, thioesters, amides, esters, aldehydes, ketones, halides, or the like. For example, a siloxane may comprise hexamethyldixiloxane (e.g., a siloxane with a plurality of methyl groups bound to the silicon). In some cases, the silicon-containing additive may comprise a plurality of silicon and oxygen atoms (e.g., a polysiloxane). Examples of polysiloxanes include, but are not limited to, cyclic polysiloxanes (e.g., hexamethylcyclotrisiloxane, octamethylcyclotetrasiloxane, decamethylcyclopentasiloxane, dodecamethylcyclohexasiloxane, etc.), linear polysiloxanes (e.g., octamethyltrisiloxane, decamethyltetrasiloxane, dodecamethylpentasiloxane, tetradecamethylhexasiloxane, polydimetylsiloxane, etc.), silazanes (e.g., hexamethyldisilazane, etc.), silicones (e.g., functionalized polysiloxanes), other functionalized siloxanes, or the like, or any combination thereof. In some cases, the silicon-containing additive comprises a silane (e.g., one or more silicon atom bound to one or more non-alkane (e.g., hydrogen) functional groups). In some cases, the silicon-containing additive may comprise silica (e.g., a silicon-oxide compound).

The silicon-containing additive may comprise one or more particles. For example, the silicon-containing additive may comprise one or more particles comprising the silicon. The one or more particles may comprise particulate (e.g., particles with a dimension greater than about 1,000 micrometers (μm)), microparticles (e.g., particles with a dimension between about 1 and about 1,000 μm), nanoparticles (e.g., particles with a dimension of less than about 1 μm), or the like, or any combination thereof. Smaller particles may provide faster reaction rates (e.g., react faster and/or at lower temperatures) due to the increased surface area to volume ratio of the smaller particles as compared to larger particles. Adjusting the particle size and/or composition can provide tuning for the reaction rate and resultant product, permitting different grades and sizes to be produced in a same apparatus by changing the composition and form of the silicon-containing additive.

The carbonaceous material may comprise a chemical with a formula of CₙHₓ or CₙHₓO_{y} where n is an integer, x is (i) between 1 and 2n+2 or (ii) less than 1 (e.g., for coal, coal tar, pyrolysis fuel oil, etc.), and y is between 0 and n. Examples of carbonaceous materials may include, but are not limited to, linear hydrocarbons (e.g., methane, ethane, propane, butane, etc.), cyclic hydrocarbons (e.g., cyclopropane, cyclobutene, cyclopentane, cyclohexane, etc.), aromatic hydrocarbons (e.g., benzene, toluene, xylenes, naphthalene, methyl naphthalene, pyrolysis fuel oil, coal tar, coal, heavy oil, oil, bio-oil, bio-diesel, other biologically derived hydrocarbons, etc.), unsaturated hydrocarbons (e.g., ethylene, propylene, acetylene, butadiene, styrene, etc.), oxygenated hydrocarbons (e.g., alcohols, ethanol, propanol, phenol, ketones, esters, ethers, carboxylic acids, anhydrides, etc.), or the like, or any combination thereof. The carbonaceous material may comprise a plurality of different carbonaceous materials. The carbonaceous material may comprise at least about 1, 2, 3, 4, 5, 6, 7, 8, 9, 10, or more different carbonaceous materials. The carbonaceous material may comprise at most about 10, 9, 8, 7, 6, 5, 4, 3, 2, or 1 different carbonaceous materials. The carbonaceous material may comprise at least about 5, 10, 15, 20, 25, 30, 35, 40, 45, 50, 55, 60, 65, 70, 75, 80, 85, 90, 95, 96, 97, 98, 99, 99.9, or more percent by weight of a single carbonaceous material as described above. The carbonaceous material may comprise at most about 99.9, 98, 97, 96, 95, 90, 85, 80, 75, 70, 65, 60, 55, 50, 45, 40, 35, 30, 25, 20, 15, 10, 5, or less percent by weight of a single carbonaceous material as described above. For example, the carbonaceous material may comprise at least about 70 percent by weight methane, ethane, or propane. In another example, the carbonaceous material can comprise at least about 70 percent by weight of a mixture of methane, ethane, and propane. The carbonaceous material may comprise a percent by weight of a single carbonaceous material as defined by any two of the preceding values. For example, the carbonaceous material may comprise from about 50 to about 70 percent of a single carbonaceous material. In some cases, the carbonaceous material may comprise one or more minor constituents (e.g., impurities). For example, the carbonaceous material may comprise nitrogen, sulfur, halogens, zinc, etc at an amount of at most about 10, 9, 8, 7, 6, 5, 4, 3, 2, 1, 0.5, 0.1, or less percent by weight.

In an operation 120, the method 100 may comprise contacting the carbonaceous material with the silicon-containing additive to generate the carbon particle in the reactor. In some cases, there may not be a reaction at a surface of the carbon particle. For example, the surface of the carbon particle can function as a complexing agent between the silicon-containing additive and the carbonaceous material or otherwise participate via a weak interaction (e.g., a dispersion interaction, a non-bonding interaction, etc.) or a strong interaction (e.g., a bonding interaction, a charged species interaction, etc.). The surface may provide a lower decomposition energy barrier for the carbonaceous material. For example, the surface may be a catalyst for the decomposition of the carbonaceous material. This may result in a non-core-shell morphology of the resultant carbon particle (e.g., the carbonaceous material may not grow on a silicon core). In some cases, the presence of the silicon-containing additive can enable a lower reactor temperature, lower energy use, or a combination thereof. Rather, the silicon particle may be contacted with a plurality of carbonaceous material molecules, which can generate a plurality of carbon nucleates which can in turn form the carbon particle. In this way, the resultant carbon particles may comprise some carbon particles with a silicon core and some carbon particles without. In some cases, the resultant carbon particles may not comprise core-shell morphologies.

In some cases, the carbon particle may comprise at least one silicon core decorated with carbon. For example, in the contacting the carbonaceous material and the silicon-containing additive, the silicon-containing additive can react faster than the carbonaceous material, which can lead to the formation of a silicon core. In this example, the carbonaceous material can then react and form carbon decoration around the silicon core. The silicon core may comprise at least silicon, silicon carbide, silicon oxycarbide, silicon dioxide, or the like, or any combination thereof. Operation 120 may comprise contacting the carbonaceous material with the silicon-containing additive to generate a plurality of carbon particles. For example, a plurality of carbon particles can be generated in a continuous flow scheme where the carbonaceous material and the silicon-containing additive can be added to a flow reactor. The plurality of carbon particles can be generated in a batch process. For example, a predetermined amount of carbonaceous material and silicon-containing additive can be added to a batch reactor, allowed to react, and the resultant carbon particles can be recovered from the batch reactor.

Operation 120 can comprise heating a thermal transfer gas. Operation 120 can comprise contacting the thermal transfer gas with the carbonaceous material and the silicon-containing additive to generate the carbon particle. Examples of thermal transfer gases include, but are not limited to, hydrogen, helium, nitrogen, neon, argon, krypton, air, water, carbon monoxide, carbon dioxide, a hydrocarbon (e.g., a gaseous carbonaceous material as described elsewhere herein), other species that exist in a gaseous state at a temperature of at least about 200° C., or the like, or any combination thereof. The thermal transfer gas may be configured to transfer heat from a heat source (e.g., a plasma source, a heat source as described elsewhere herein, etc.) to the carbonaceous material and/or the silicon-containing additive. The thermal transfer gas may be inert to the reaction between the carbonaceous material and the silicon-containing additive. For example, an argon thermal transfer gas may not react with the carbonaceous material and the silicon-containing additive. The thermal transfer gas may comprise at least about 5, 10, 15, 20, 25, 30, 35, 40, 45, 50, 55, 60, 65, 70, 75, 80, 85, 90, 95, 96, 97, 98, 99, 99.9, or more percent by volume of a single thermal transfer gas as described above. The thermal transfer gas may comprise at most about 99.9, 98, 97, 96, 95, 90, 85, 80, 75, 70, 65, 60, 55, 50, 45, 40, 35, 30, 25, 20, 15, 10, 5, or less percent by volume of a single thermal transfer gas as described above. The thermal transfer gas may comprise a percent by volume of a single thermal transfer gas as described above in a range as defined by any two of the preceding values. For example, the thermal transfer gas can comprise between about 60 and about 100 percent hydrogen by volume.

The thermal transfer gas may be heated via use of a heating system (e.g., plasma system) as described elsewhere herein. For example, the thermal transfer gas can be heated using a plasma torch as described elsewhere herein. The thermal transfer gas may be heated to a temperature of at least about 500, 550, 600, 650, 700, 750, 800, 850, 900, 950, 1,000, 1,100, 1,200, 1,300, 1,400, 1,500, 1,550, 1,600, 1,650, 1,700, 1,750, 1,800, 1,850, 1,900, 1,950, 2,000, 2,100, 2,200, 2,300, 2,400, 2,500, 2,600, 2,700, 2,800, 2,900, 3,000, 3,100, 3,200, 3,300, 3,400, 3,500, 3,600, or more degrees Celsius. The thermal transfer gas may be heated to a temperature of at most about 3,600, 3,500, 3,400, 3,300, 3,200, 3,100, 3,000, 2,900, 2,800, 2,700, 2,600, 2,500, 2,400, 2,300, 2,200, 2,100, 2,000, 1,950, 1,900, 1,850, 1,800, 1,750, 1,700, 1,650, 1,600, 1,550, 1,500, 1,400, 1,300, 1,200, 1,100, 1,000, 950, 900, 850, 800, 750, 700, 650, 600, 550, 500, or less degrees Celsius. The thermal transfer gas may be heated to a temperature in a range as defined by any two of the preceding values. For example, the thermal transfer gas can be heated to a temperature from about 1200 to about 1700 degrees Celsius. The thermal transfer gas may be configured not to incorporate or substantially not incorporate into the products of the methods and systems described herein. For example, the thermal transfer gas may be inert.

The contacting the thermal transfer gas with the carbonaceous material and the silicon-containing additive may be performed in the reactor. For example, the thermal transfer gas can be heated in a first reactor portion comprising a heating source (e.g., a plasma torch), and the thermal transfer gas can be flowed into contact with the carbonaceous material and the silicon-containing additive. In some cases, the thermal transfer gas, the carbonaceous material, and the silicon-containing additive can be allowed to mix in a reactor chamber for a predetermined amount of time (e.g., a reactor residence time). The thermal transfer gas can provide heat to the carbonaceous material and the silicon-containing additive, thereby causing a decomposition reaction to occur which can yield the carbon particle. The carbonaceous material and the silicon-containing additive can be reacted in a presence of a plasma. For example, the carbonaceous material and the silicon-containing additive can be added to a reaction in a same portion as a plasma torch. In this example, the plasma torch can provide heat to react the carbonaceous product and the silicon-containing additive.

During or subsequent to operation 120, wall fouling may form in the reactor. The wall fouling may comprise overreacted carbonaceous materials (e.g., that have reacted to form large agglomerates). The wall fouling may result in errors during the production of the carbon particle (e.g., clogging, increased impurities, poor fluid flow, carbon particle property fluctuations (e.g., oal absorption number, surface area, etc.), etc.). Addition of a silicon-containing additive can reduce the amount of wall fouling formed as compared to when a silicon-containing additive is not used. The wall fouling may comprise at least about 0.01, 0.05, 0.1, 0.5, 1, 2, 3, 4, 5, 6, 7, 8, 9, 10, or more percent of the carbonaceous material by weight. The wall fouling may comprise at most about 10, 9, 8, 7, 6, 5, 4, 3, 2, 1, 0.5, 0.1, 0.05, 0.01, or less percent of the carbonaceous material by weight. The wall fouling may comprise a substantially same ratio of silicon to carbon as the carbon particle. For example, the wall fouling may have a same composition as the carbon particle, but comprise a larger average particle size. The wall fouling may have a ratio of silicon to carbon different from the carbon particle. For example, the silicon can be less present in the wall fouling as compared to in the carbon particle.

The carbonaceous material may be converted to the carbon particle with a given yield (e.g., the amount of the carbonaceous material that is present in the carbon particle). The carbonaceous material may be converted to the carbon particle with a yield of at least about 5, 10, 15, 20, 25, 30, 35, 40, 45, 50, 55, 60, 65, 70, 75, 80, 85, 90, 95, 96, 97, 98, 99, 99.9, or more percent on a weight basis. The carbonaceous material may be converted to the carbon particle with a yield of at most about 99.9, 98, 97, 96, 95, 90, 85, 80, 75, 70, 65, 60, 55, 50, 45, 40, 35, 30, 25, 20, 15, 10, 5, or less percent on a weight basis. The generating the carbon particle may be performed at a rate of at least about 1, 5, 10, 50, 100, 200, 300, 400, 500, 600, 700, 800, 900, 1,000, 1,500, or more kilograms/hour (kg/h) of carbon particle production. The generating the carbon particle may be performed at a rate of at most about 1,500, 1,000, 900, 800, 700, 600, 500, 400, 300, 200, 100, 50, 10, 5, 1, or less kilograms/hour (kg/h) of carbon particle production. An energy used to produce the carbon particle may be reduced by at least about 0.01, 0.05, 0.1, 0.5, 1, 2, 3, 4, 5, 6, 7, 8, 9, 10, 15, 20, or more percent as compared to a method without addition of said silicon-containing additive (e.g., at a same level of residual carbonaceous feedstock or total rate of carbon particles). An energy used to produce the carbon particle may be reduced by at most about 20, 15, 10, 9, 8, 7, 6, 5, 4, 3, 2, 1, 0.5, 0.1, 0.05, 0.001, or less percent as compared to a method without addition of said silicon-containing additive (e.g., at a same level of residual carbonaceous feedstock or total rate of carbon particles).

In another aspect, the present disclosure provides a method for generating a carbon particle. A silicon-containing additive and a carbonaceous material can be provided to a reactor. In the reactor, the carbonaceous material can be decomposed to form the carbon particle in a presence of a plasma and the silicon-containing additive.

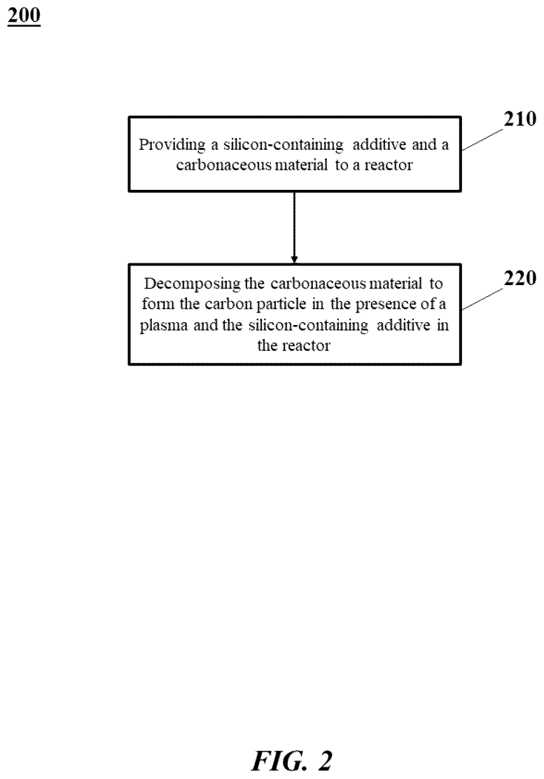

FIG. 2 is a flowchart of an example method 200 for generating a carbon particle, according to some embodiments. In an operation 210, the method 200 may comprise providing a silicon-containing additive and a carbonaceous material to a reactor. The silicon-containing additive, the reactor, and the carbonaceous material may be as described elsewhere herein.

Operation 210 may comprise providing the silicon-containing additive in a thermal transfer gas. The thermal transfer gas may be as described elsewhere herein. For example, the thermal transfer gas may comprise at least about 60 percent hydrogen. In some cases, the thermal transfer gas can be provided to a plasma region of the reactor, become heated in the plasma region, and transfer the heat from the plasma region to the carbonaceous material and/or the silicon-containing additive. The silicon-containing additive can be added to the thermal transfer gas prior to contacting the carbonaceous material. Pre-loading the silicon-containing additive can permit a reaction to occur prior to the loading of the carbonaceous material where silicon containing nucleates can be formed. The silicon-containing nucleates may serve as substrates for carbon particle growth. In some cases, the silicon-containing additive can be provided in a material stream comprising the carbonaceous material. For example, the silicon-containing additive can be added as a gas to a gaseous carbonaceous material. Adding the silicon-containing additive to the carbonaceous material may permit use of the methods described herein without changing the physical configuration of the reactor. This may ease implementation as well as not require large changes to an existing carbon particle generating plant.

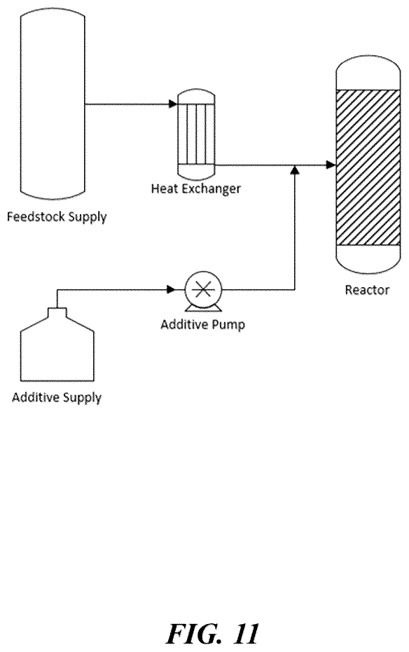

A plasma reactor may comprise one or more of a plasma torch (e.g., an electrical torch configured to produce a plasma), a plasma torch region (e.g., an enclosed space around the torch), a throat (e.g., an area where the size of the area is constricted with respect to the area on either side of the throat), one or more injectors (e.g., injectors configured to provide a feedstock (e.g., a carbonaceous material, a silicon-containing additive, etc.) to the reactor), one or more reaction zones (e.g., volumes configured as residence areas for a reaction to occur), or the like, or any combination thereof. The plasma may be a thermal plasma. The plasma may be a non-thermal plasma. The addition of the silicon-containing additive may be performed by use of a vaporizer into the carbonaceous material feedstock. For example, the silicon-containing additive can be added to the feedstock prior to the feedstock being added to the reactor. By pre-loading the silicon-containing additive in this way, lower risk (e.g., safer) silicon-containing additives may be used (e.g., light siloxanes) as opposed to a direct injection of the silicon-containing additive (e.g., more reactive silanes). Such addition may comprise use of a container (e.g., drum, bag, etc.) of liquid silicon-containing additive and a pump configured to handle the liquid (e.g., be resistant to reaction with the liquid (e.g., lined with inert plastic, stainless steel, etc.)). The addition may comprise use of spray nozzles to spray the silicon-containing additive into the carbonaceous material stream. The carbonaceous material may be pre-heated to aid in vaporization of the liquid spray. Subsequent to vaporization, the carbonaceous material/silicon-containing additive can be injected into the reactor as described elsewhere herein. The silicon-containing additive may be added in a same part of the reactor as the carbonaceous material feedstock. The silicon-containing additive may be added to the reactor downstream (e.g., further in a direction of gas flow) from the carbonaceous material feedstock. The injectors for the silicon-containing additive may be downstream of the carbonaceous material feedstock injectors by at least about 5, 10, 50, 100, 150, 200, 250, 300, 350, 400, 450, 500, 650, 700, 750, 800, 900, 1,000, 1,100, 1,200, 1,300, 1,400, 1,500, 1,600, 1,700, 1,800, 1,900, 2,000, 2,100, 2,200, 2,300, 2,400, 2,500, 2,600, 2,700, 2,800, 2,900, 3,000, 3,100, 3,200, 3,300, 3,400, 3,500, 3,600, 3,700, 3,800, 3,900, 4,000, 4,100, 4,200, 4,300, 4,400, 4,500, 4,600, 4,700, 4,800, 4,900, 5,000, or more millimeters. The injectors for the silicon-containing additive may be downstream of the carbonaceous material feedstock injectors by at most about 5,000, 4,900, 4,800, 4,700, 4,600, 4,500, 4,400, 4,300, 4,200, 4,100, 4,000, 3,900, 3,800, 3,700, 3,600, 3,500, 3,400, 3,300, 3,200, 3,100, 3,000, 2,900, 2,800, 2,700, 2,600, 2,500, 2,400, 2,300, 2,200, 2,100, 2,000, 1,900, 1,800, 1,700, 1,650, 1,600, 1,550, 1,500, 1,400, 1,300, 1,200, 1,100, 1,000, 950, 900, 850, 800, 750, 700, 650, 600, 550, 500 450, 400, 350, 300, 250, 200, 150, 100, 50, 10, 5, or less millimeters. The injectors for the silicon-containing additive may be downstream of the carbonaceous material feedstock injectors by a value in a range as defined by any two of the proceeding values. FIG. 11 shows an example of an additive addition scheme, according to some embodiments. In some cases, the silicon-containing additive is not mixed with the carbonaceous material prior to the reactor.

In an operation 220, the method 200 may comprise in the reactor, decomposing the carbonaceous material to form the carbon particle in a presence of a plasma and the silicon-containing additive. Operation 220 may comprise decomposing the carbonaceous material in the presence of the plasma and the silicon containing additive to generate a plurality of carbon particles. Operation 220 may comprise decomposing the carbonaceous material in the presence of (i) a thermal transfer gas heated to a temperature sufficient to enable decomposition of the carbonaceous material but not reach a plasma state and (ii) the silicon containing additive to generate a plurality of carbon particles. An example of a decomposition pathway for methane may be from methane to a CH₃ radical to ethylene to acetylene, where some combination of these molecules and additional dehydrogenation can form polycyclic aromatic hydrocarbons that may further react to form the carbon particles.

The decomposing may be performed at a temperature of at least about 500, 550, 600, 650, 700, 750, 800, 850, 900, 950, 1,000, 1,100, 1,200, 1,300, 1,400, 1,500, 1,550, 1,600, 1,650, 1,700, 1,750, 1,800, 1,850, 1,900, 1,950, 2,000, 2,100, 2,200, 2,300, 2,400, 2,500, 2,600, 2,700, 2,800, 2,900, 3,000, 3,100, 3,200, 3,300, 3,400, 3,500, 3,600, or more degrees Celsius. The decomposing may be performed at a temperature of at most about 3,600, 3,500, 3,400, 3,300, 3,200, 3,100, 3,000, 2,900, 2,800, 2,700, 2,600, 2,500, 2,400, 2,300, 2,200, 2,100, 2,000, 1,950, 1,900, 1,850, 1,800, 1,750, 1,700, 1,650, 1,600, 1,550, 1,500, 1,400, 1,300, 1,200, 1,100, 1,000, 950, 900, 850, 800, 750, 700, 650, 600, 550, 500, or less degrees Celsius. The decomposing may be performed in a temperature range as defined by any two of the preceding values. For example, the decomposing may be performed at a temperature from about 1500 to about 2100 degrees Celsius. The temperature may be a calculated reaction temperature. For example, the temperature may be calculated by a combination of the complete mixing of material streams into the reactor (e.g., feedstock streams, transfer gas streams, etc.), power addition from a heat source (e.g., a plasma torch), coolant heat losses between the heat source and a mixing area (e.g., heat lost to cooling the reactor), material stream conditions (e.g., composition, flow rate, temperature, pressure, etc.), specific heat of the reactor materials and material streams, latent heat of the reactor, reaction energy of the reaction occurring in the reactor (e.g., is the reaction endothermic or exothermic, etc.), or the like, or any combination thereof. Measurements of the reactor temperature may comprise direct measurements of the wall temperatures, measurement of heat losses (e.g., by measuring inlet and outlet temperatures), flow rate measurements, feedstock flow, quench flow, or the like, or any combination thereof. Gas composition measurements of the output of the reactor may be used to evaluate effectiveness of the feedstock conversion. Where practicable, redundancy may be used to validate measurements and reduce a risk of data loss in the event of sensor failure. The temperature may be at least about 5, 10, 15, 20, 25, 30, 35, 40, 45, 50, 55, 60, 65, 70, 75, 80, 85, 90, 95, 100, 200, 300, 400, 500, 600, 700, 800, 900, 1,000 or more degrees Celsius lower than a temperature of a method without said silicon-containing additive (e.g., at a same level of residual carbonaceous feedstock or total rate of carbon particles). The temperature may be at most about 1,000, 900, 800, 700, 600, 500, 400, 300, 200, 100, 95, 90, 85, 80, 75, 70, 65, 60, 55, 50, 45, 40, 35, 30, 25, 20, 15, 10, 5, or less degrees Celsius lower than a temperature of a method without said silicon-containing additive (e.g., at a same level of residual carbonaceous feedstock or total rate of carbon particles).

The decomposing of the carbonaceous material may have a reaction rate of at least about 1.05, 1.1, 1.15, 1.2, 1.25, 1.3, 1.35, 1.4, 1.45, 1.5, 1.55, 1.6, 1.65, 1.7, 1.75, 1.8, 1.85, 1.9, 1.95, 2, 2.5, 3, 3.5, or more times faster with addition of a silicon-containing additive than without. The decomposing of the carbonaceous material may have a reaction rate of at most about 3.5, 3, 2.5, 2, 1.95, 1.9, 1.85, 1.8, 1.75, 1.7, 1.65, 1.6, 1.55, 1.5, 1.45, 1.4, 1.35, 1.3, 1.25, 1.2, 1.15, 1.1, 1.05, or less times faster with addition of a silicon-containing additive than without. A reaction coefficient may be calculated by the equation

$$k = \frac{ln \frac{{A}_{t}}{{A}_{0}}}{t} ,$$

where k may be a global rate coefficient (e.g., a rate coefficient of the reaction taking into account all or substantially all processes of the reaction), Aₜ may be a concentration of the carbonaceous material (e.g., feedstock) at the end of a reaction, A₀ may be a concentration of the carbonaceous material at a start of the reaction, and t may be the residence time in the reactor. The residence time may be the same for a reaction with or without a silicon-containing additive. The value of k may be normalized to the reaction without use of the silicon-containing additive. For example, for a first reaction not comprising a silicon-containing additive, values of A₀, Aₜ, and k may be 100%, 10%, and 1, while values for a reaction comprising a silicon containing additive may be 100%, 2.5%, and 1.6. In this example, a 60% increase in the global reaction rate of the conversion of the carbonaceous material to carbon particles can be realized by use of a silicon-containing additive. In this example, the change may be related to a change in activation energy of the reaction.

During or subsequent to operation 220, wall fouling may form in the reactor. The wall fouling may comprise overreacted carbonaceous materials (e.g., that have reacted to form large solid carbon species (e.g., solid carbon species that are difficult to break up)). The wall fouling may result in reduced yield during the production of the carbon particle (e.g., clogging, increased impurities, decreased yields, etc.). Addition of a silicon-containing additive can reduce the amount of wall fouling formed as compared to when a silicon-containing additive is not used. The wall fouling may comprise at least about 0.01, 0.05, 0.1, 0.5, 1, 2, 3, 4, 5, 6, 7, 8, 9, 10, or more percent of the carbonaceous material by weight. The wall fouling may comprise at most about 10, 9, 8, 7, 6, 5, 4, 3, 2, 1, 0.5, 0.1, 0.05, 0.01, or less percent of the carbonaceous material by weight. The wall fouling may comprise a substantially same ratio of silicon to carbon as the carbon particle. For example, the wall fouling may have a same composition as the carbon particle, but comprise a larger average particle size. The wall fouling may have a ratio of silicon to carbon different from the carbon particle. For example, the silicon can be less present in the wall fouling as compared to in the carbon particle.

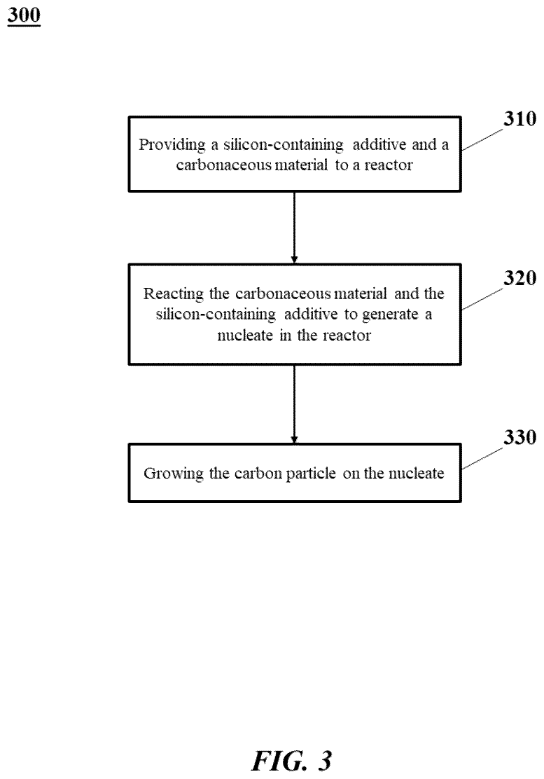

FIG. 3 is a flowchart of an example method 300 for generating a carbon particle, according to some embodiments. In an operation 310, the method 300 may comprise providing a silicon-containing additive and a carbonaceous material to a reactor. The silicon-containing additive, the reactor, and the carbonaceous material may be as described elsewhere herein.

The ratio of silicon-containing additive to the carbonaceous material may be at least about 0.000001, 0.000005, 0.00001, 0.00005, 0.001, 0.005, 0.01, 0.05, 0.1, 0.5, 1, or more by weight. The ratio of silicon-containing additive to the carbonaceous material may be at most about 1, 0.5, 0.1, 0.05, 0.01, 0.005, 0.001, 0.0005, 0.0001, 0.00005, 0.00001, 0.000005, 0.000001, or less by weight. The ratio of silicon-containing additive to the carbonaceous material may be of a range as defined by any two of the preceding values. For example, the ratio may be from about 0.01 to about 0.1 by weight.

In another operation 320, the method 300 may comprise reacting the carbonaceous material and the silicon-containing additive to generate a nucleate in the reactor. The nucleate may comprise at least one silicon core. The reacting may comprise reacting in a plasma reactor as described elsewhere herein. The reacting may take place at a temperature as described elsewhere herein.

The reacting may comprise reacting the carbonaceous material and the silicon-containing additive at a same or substantially same time. For example, the silicon-containing additive can have a faster reaction rate, which can result in the formation of silicon cores that the carbonaceous material subsequently reacts onto. In this example, the silicon-containing additive can be added into the carbonaceous material prior to introduction to the reactor. For example, the silicon-containing additive and the carbonaceous material can be mixed (e.g., in a gas phase, in a liquid phase, etc.) and subsequently piped into the reactor.

The reacting may comprise reacting the silicon-containing additive and subsequently reacting the carbonaceous material. For example, the silicon-containing additive can be reacted to form the silicon core, and the carbonaceous material can be subsequently reacted onto the silicon core. In this example, the silicon-containing additive can be added into the reactor prior to the carbonaceous material being added to the reactor. For example, the silicon-containing additive can be piped into the reactor closer to the heat source (e.g., further upstream) from where the carbonaceous material is added to the reactor.

The silicon core may comprise at least about 40, 45, 50, 55, 60, 65, 70, 75, 80, 85, 90, 95, 96, 97, 98, 99, or more percent silicon. The silicon core may comprise at most about 99, 98, 97, 96, 95, 90, 85, 80, 75, 70, 65, 60, 55, 50, 45, 40, or less percent silicon. The silicon core may comprise an amount of silicon in a range as defined by any two of the preceding values. The silicon core may be at least about 1, 5, 10, 20, 30, 40, 50, 60, 70, 80, 90, 100, 200, 300, 400, 500, or more nanometers in diameter. The silicon core may be at most about 500, 400, 300, 200, 100, 90, 80, 70, 60, 50, 40, 30, 20, 10, 5, 1, or fewer nanometers in diameter. A plurality of silicon cores may have diameters in a range as defined by any two of the preceding values. The silicon core may comprise pure silicon, silicon carbide, silicon oxycarbides, silicon oxides, silicon nitrides, or the like, or any combination thereof. The silicon core may provide a lower energy surface for growth of carbonaceous material. Operation 320 may comprise generating a plurality of nucleates each comprising a silicon core. For example, the reactor can be configured to generate a plurality of nucleates to scale up a production of carbon particles. The core may be located within the carbon particle, on a surface of the carbon particle, or the like. The core may be located separate from the carbon particle.

Operation 320 may be performed in a presence of a plasma. The plasma may be a plasma as described elsewhere herein. The plasma may be configured to provide heat to the carbonaceous material and the silicon-containing additive. For example, the plasma can heat a thermal transfer gas that is configured to then provide heat to the carbonaceous material and the silicon-containing additive. Operation 320 may be performed in thermal contact with a plasma. For example, the thermal contact can be via a transfer gas. In some cases, operation 320 can be performed in a direct presence of a plasma. For example, operation 320 can be performed in a chamber where a plasma is formed.

In another operation 330, the method 300 may comprise growing the carbon particle on the nucleate. For example, the nucleate can be formed, and subsequently the carbonaceous material can be used to grow carbon onto the nucleate. In this example, the nucleate with the carbonaceous material grown onto it can be the carbon particle. The carbon particle may comprise at least about 5, 10, 15, 20, 25, 30, 35, 40, 45, 50, 55, 60, 65, 70, 75, 80, 85, 90, 95, 96, 97, 98, 99, 99.9, or more percent carbon by weight. The carbon particle may comprise at most about 99.9, 98, 97, 96, 95, 90, 85, 80, 75, 70, 65, 60, 55, 50, 45, 40, 35, 30, 25, 20, 15, 10, 5, or less percent carbon by weight. The carbon particle may comprise carbon black.

Operation 330 may be performed in a presence of a plasma. For example, operation 330 can be performed in a same chamber as a plasma is formed in, thereby providing energy for the growth of the carbon particle onto the nucleate. The plasma may be a plasma as described elsewhere herein. Operation 330 may be performed in an absence of a plasma. For example, a plasma may be used to heat a transfer gas, the transfer gas can be flowed away from the plasma, and subsequently used to provide energy for operation 330.

Operation 330 may comprise growing a plurality of carbon particles on a plurality of nucleates. For example, a reactor can be configured to produce a plurality of carbon particles in a scaled-up reaction. Operation 330 may comprise growing a plurality of carbon particles on a nucleate. For example, a plurality of carbon particles can be grown on the surface of a nucleate to form a cluster of carbon particles. In some cases, the nucleate may be comprised within a single carbon particle (e.g., a core-shell configuration). In some cases, a plurality of carbon particles grown onto a single nucleate can have an aciniform structure. In some cases, silicon containing particles may grow separately from the carbon particles and provide for lower energy decomposition of the carbonaceous material (e.g., may function as a catalyst).

During or subsequent to operation 330, wall fouling may form in the reactor. The wall fouling may comprise overreacted carbonaceous materials (e.g., that have reacted to form large agglomerates). The wall fouling may result in errors during the production of the carbon particle (e.g., clogging, increased impurities, etc.). Addition of a silicon-containing additive can reduce the amount of wall fouling formed as compared to when a silicon-containing additive is not used. The wall fouling may comprise at least about 0.01, 0.05, 0.1, 0.5, 1, 2, 3, 4, 5, 6, 7, 8, 9, 10, or more percent of the carbonaceous material by weight. The wall fouling may comprise at most about 10, 9, 8, 7, 6, 5, 4, 3, 2, 1, 0.5, 0.1, 0.05, 0.01, or less percent of the carbonaceous material by weight. The wall fouling may comprise a substantially same ratio of silicon to carbon as the carbon particle. For example, the wall fouling may have a same composition as the carbon particle, but comprise a larger average particle size. The wall fouling may have a ratio of silicon to carbon different from the carbon particle. For example, the silicon can be less present in the wall fouling as compared to in the carbon particle.

In another aspect, the present disclosure provides a carbon particle or carbonaceous material. The carbon particle may comprise a structure or a non-carbon portion. An ash comprising the structure (e.g., produced from the carbon particle via ASTM D1506) or the non-carbon portion may have a surface area of at least about 50, 60, 70, 80, 90, 100, 110, 120, 130, 140, 150, 160, 170, 180, 190, 200, 225, 250, 275, 300, 400, 500, or more square meters per gram. The ash may have an unexpectedly large surface area. The unexpectedly large surface area may be due to a co-deposition of the material of the ash (e.g., silicon) with the carbon of the carbon particle. In this way, when the carbon is removed by ashing, the resultant ash may have a high surface area. The carbon particle may be carbon black as described elsewhere herein. The structure or non-carbon portion may comprise silicon. The structure or non-carbon portion may comprise at least about 50, 60, 70, 80, 90, 95, or more percent silicon. The surface area of the non-carbon portion may be determined by ashing using ASTM D1506. The non-carbon portion may comprise at most about 1, 2, 3, 4, 5, 6, 7, 8, 9, 10, 11, 12, 13, 14, 15, 16, 17, 18, 19, 20, 25, 30, 40, 50, or more percent of the weight of the carbon particle. The carbon particle may have a lattice constant (L_{c}) of at least about 1, 2, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.5, 5.0, or more nanometers. The ash comprising the structure or the non-carbon portion may have a pour density of at least about 30, 40, 50, 60, 70, 80, 90, 100, 110, 120, 130, 140, 150, 160, 170, 180, 190, 200, or more kilograms per cubic meter. The ash comprising the structure or the non-carbon portion may have a pour density of at most about 200, 190, 180, 170, 160, 150, 140, 130, 120, 110, 100, 90, 80, 70, 60, 50, 40, 30, or less kilograms per cubic meter.

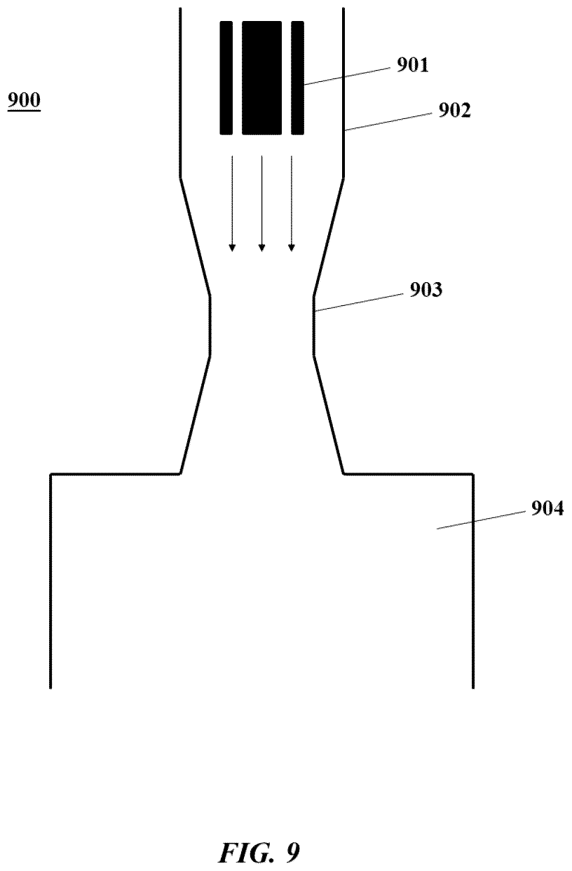

FIG. 9 shows an example of a plasma reactor 900, according to some embodiments. The plasma reactor may be configured to execute the methods as described elsewhere herein. For example, the plasma reactor can be configured to generate carbon particles as described elsewhere herein. The plasma reactor may comprise a torch region 902, a throat region 903, and/or a reactor region 904. The torch region may comprise one or more plasma torches 901. The one or more plasma torches may comprise at least about 1, 2, 3, 4, 5, 6, 7, 8, 9, 10, or more plasma torches. The one or more plasma torches may comprise at most about 10, 9, 8, 7, 6, 5, 4, 3, 2, or 1 plasma torch. The one or more plasma torches may be configured to provide a plasma to the torch region. For example, the one or more plasma torches can be configured to transform a gas (e.g., a transfer gas) into a plasma with aid of electrical energy. The plasma may be configured for use as a reactant in a carbon particle generating method. For example, the plasma can be used to provide heat to a carbon particle generating method. The plasma torch may comprise an electrically conductive material. Examples of electrically conductive materials include, but are not limited to, carbon (e.g., graphite, glassy carbon, etc.), metals (e.g., iron, tungsten, gold, etc.), alloys (e.g., steel, etc.), polymers (e.g., conductive polymers), or the like, or any combination thereof. The plasma torch may comprise a plurality of segments. For example, the plasma torch can comprise a plurality of electrode portions (e.g., an anode, a cathode, a ground, or a combination thereof).

The lines shown in FIG. 9 may indicate a flow direction of a gas (e.g., a transfer gas) flowing through the plasma reactor. For example, the direction of gas flow can be from the torch region through the throat region into the reactor region. A transfer gas may be introduced to the plasma reactor upstream of the torch area. For example, the transfer gas can be introduced via a pipe disposed upstream of the plasma torch. A transfer gas may be introduced to the plasma reactor before the throat region, in the throat region, after the throat region, in the reactor region, or any combination thereof. Introducing transfer gas after the plasma torch may impact the temperature, flow rate, reaction rate, concentration, dilution, etc. of the plasma reactor.

The plasma reactor may comprise one or more carbonaceous material injectors. The carbonaceous material injectors can be located upstream of the torch region, in the torch region, in the throat region, in the reactor region, or any combination thereof. Each region of the plasma reactor may comprise one or more carbonaceous material injectors. The one or more carbonaceous material injectors may be distributed radially around the plasma reactor. The one or more carbonaceous material injectors may be configured to inject a same type of carbonaceous material. For example, each carbonaceous material injector of the one or more carbonaceous material injectors can be configured to inject methane. The one or more carbonaceous material injectors may be configured to inject a plurality of types of carbonaceous materials.

The reactor region 904 may be configured to have a residence time of at least about 0.01, 0.05, 0.1, 0.2, 0.3, 0.4, 0.5, 0.6, 0.7, 0.8, 0.9, 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, 4, 5, 6, or more seconds. The reactor region may be configured to have a residence time of at most about 6, 5, 4, 3.9, 3.8, 3.7, 3.6, 3.5, 3.4, 3.3, 3.2, 3.1, 3, 2.9, 2.8, 2.7, 2.6, 2.5, 2.4, 2.3, 2.2, 2.1, 2, 1.9, 1.8, 1.7, 1.6, 1.5, 1.4, 1.3, 1.2, 1.1, 1, 0.9, 0.8, 0.7, 0.6, 0.5, 0.4, 0.3, 0.2, 0.1, 0.05, 0.01, or fewer seconds. The reactor region may be configured to have a residence time in a range as defined by any two of the preceding values. For example, the reactor region may be configured to have a residence time from about 0.2 to about 3 seconds. The residence time may be the time that the gas mixture spends at a temperature of greater than about 1,100° C. The reactor may comprise no or substantially no restriction between regions 902 and 904. Such a reactor may generate larger particles (e.g., not carbon black) comprising a large primary particle size.

### Computer Systems

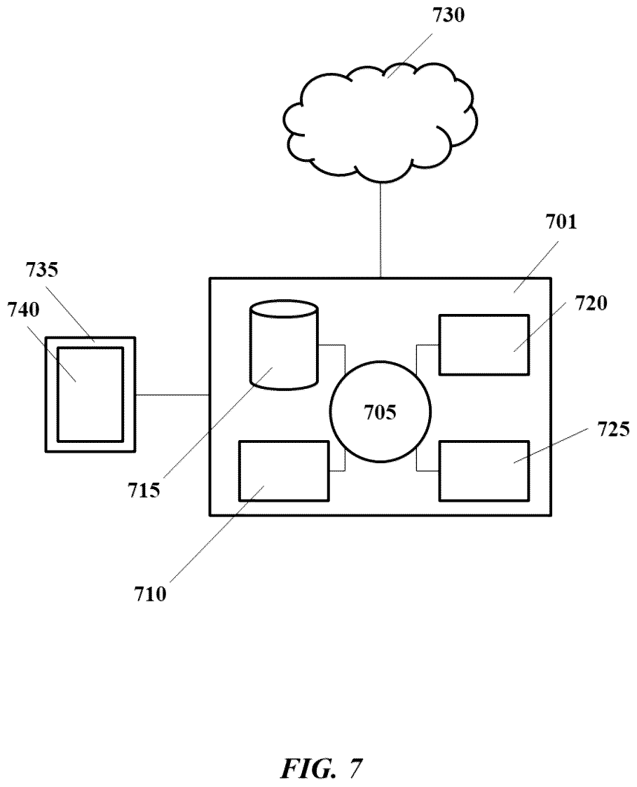

The present disclosure provides computer systems that are programmed to implement methods of the disclosure. FIG. 7 shows a computer system 701 that is programmed or otherwise configured to implement the methods and/or control the systems of the present disclosure. The computer system 701 can regulate various aspects of the present disclosure, such as, for example, a reactor configured to react carbonaceous materials and silicon-containing additives. The computer system 701 can be an electronic device of a user or a computer system that is remotely located with respect to the electronic device. The electronic device can be a mobile electronic device.

The computer system 701 includes a central processing unit (CPU, also “processor” and “computer processor” herein) 705, which can be a single core or multi core processor, or a plurality of processors for parallel processing. The computer system 701 also includes memory or memory location 710 (e.g., random-access memory, read-only memory, flash memory), electronic storage unit 715 (e.g., hard disk), communication interface 720 (e.g., network adapter) for communicating with one or more other systems, and peripheral devices 725, such as cache, other memory, data storage and/or electronic display adapters. The memory 710, storage unit 715, interface 720 and peripheral devices 725 are in communication with the CPU 705 through a communication bus (solid lines), such as a motherboard. The storage unit 715 can be a data storage unit (or data repository) for storing data. The computer system 701 can be operatively coupled to a computer network (“network”) 730 with the aid of the communication interface 720. The network 730 can be the Internet, an internet and/or extranet, or an intranet and/or extranet that is in communication with the Internet. The network 730 in some cases is a telecommunication and/or data network. The network 730 can include one or more computer servers, which can enable distributed computing, such as cloud computing. The network 730, in some cases with the aid of the computer system 701, can implement a peer-to-peer network, which may enable devices coupled to the computer system 701 to behave as a client or a server.

The CPU 705 can execute a sequence of machine-readable instructions, which can be embodied in a program or software. The instructions may be stored in a memory location, such as the memory 710. The instructions can be directed to the CPU 705, which can subsequently program or otherwise configure the CPU 705 to implement methods of the present disclosure. Examples of operations performed by the CPU 705 can include fetch, decode, execute, and writeback.

The CPU 705 can be part of a circuit, such as an integrated circuit. One or more other components of the system 701 can be included in the circuit. In some cases, the circuit is an application specific integrated circuit (ASIC).

The storage unit 715 can store files, such as drivers, libraries and saved programs. The storage unit 715 can store user data, e.g., user preferences and user programs. The computer system 701 in some cases can include one or more additional data storage units that are external to the computer system 701, such as located on a remote server that is in communication with the computer system 701 through an intranet or the Internet.

The computer system 701 can communicate with one or more remote computer systems through the network 730. For instance, the computer system 701 can communicate with a remote computer system of a user. Examples of remote computer systems include personal computers (e.g., portable PC), slate or tablet PC's (e.g., Apple® iPad, Samsung Galaxy Tab), telephones, Smart phones (e.g., Apple® iPhone, Android-enabled device, Blackberry®), or personal digital assistants. The user can access the computer system 701 via the network 730.

Methods as described herein can be implemented by way of machine (e.g., computer processor) executable code stored on an electronic storage location of the computer system 701, such as, for example, on the memory 710 or electronic storage unit 715. The machine executable or machine readable code can be provided in the form of software. During use, the code can be executed by the processor 705. In some cases, the code can be retrieved from the storage unit 715 and stored on the memory 710 for ready access by the processor 705. In some situations, the electronic storage unit 715 can be precluded, and machine-executable instructions are stored on memory 710.

The code can be pre-compiled and configured for use with a machine having a processer adapted to execute the code, or can be compiled during runtime. The code can be supplied in a programming language that can be selected to enable the code to execute in a pre-compiled or as-compiled fashion.

Aspects of the systems and methods provided herein, such as the computer system 701, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such as memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 701 can include or be in communication with an electronic display 735 that comprises a user interface (UI) 740 for providing, for example, an interface for controlling a reactor. Examples of UI's include, without limitation, a graphical user interface (GUI) and web-based user interface.

Methods and systems of the present disclosure can be implemented by way of one or more algorithms. An algorithm can be implemented by way of software upon execution by the central processing unit 705. The algorithm can, for example, implement production of different carbon particles based on user provided parameters.

The following examples are illustrative of certain systems and methods described herein and are not intended to be limiting.

### Example 1—Yield Improvements from Using a Silicon-Containing Additive

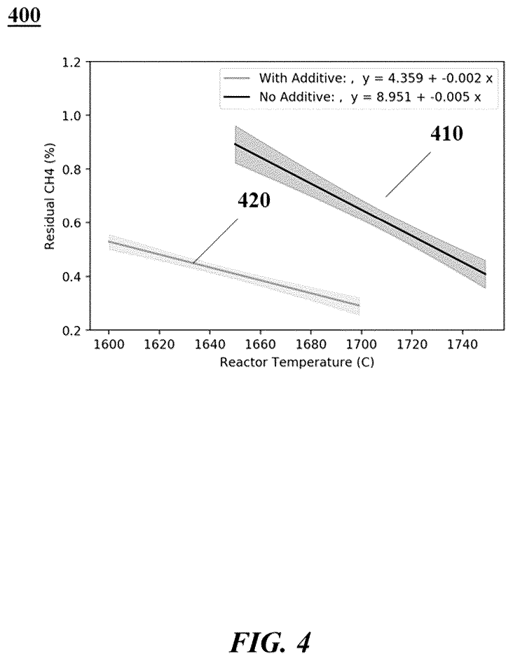

FIG. 4 is an example plot 400 of a residual amount of methane present in a gas output of a reactor, according to some embodiments. Though described herein with respect to methane, any carbonaceous precursor of the present disclosure can be used. A reactor operating to produce carbon particles in an absence of a silicon-containing additive can have a residual methane to temperature plot (with shaded error bars) as shown in plot 410. As the temperature of the reactor increases, the amount of residual methane can decrease. This can be due to the increased reaction rate observed at higher temperatures. In a reactor where a silicon-containing additive is added to the reactor, a residual methane plot such as plot 420 may be observed. Of note, the amount of residual methane detected after a reaction can be lower in the silicon-containing additive case than in the straight carbonaceous material case. Such a decrease in residual methane can result in improved yields of carbon particles, reduced electricity usage in the generation of the carbon particles, lower reactor temperatures, reduced power usage, as well as other benefits discussed herein. The amount of residual carbon in the system may be related to the completeness of a reaction of the carbonaceous material feedstock. For example, a more complete reaction can lead to decreased residual carbon in the system. The methods and systems of the present disclosure can provide a residual carbon of at most about 5, 4.5, 4, 3.5, 3, 2.5, 2, 1.9, 1.8, 1.7, 1.6, 1.5, 1.4, 1.3, 1.2, 1.1, 1, 0.9, 0.8, 0.7, 0.6, 0.5, 0.4, 0.3, 0.2, 0.1, or less percent. Reducing residual carbon can improve reactor efficiency (e.g., increase the amount of carbon particles produced in a given reaction run), reduce fouling (e.g., less residual carbon can provide less feedstock to react in other parts of the reactor to generate fouling), etc.

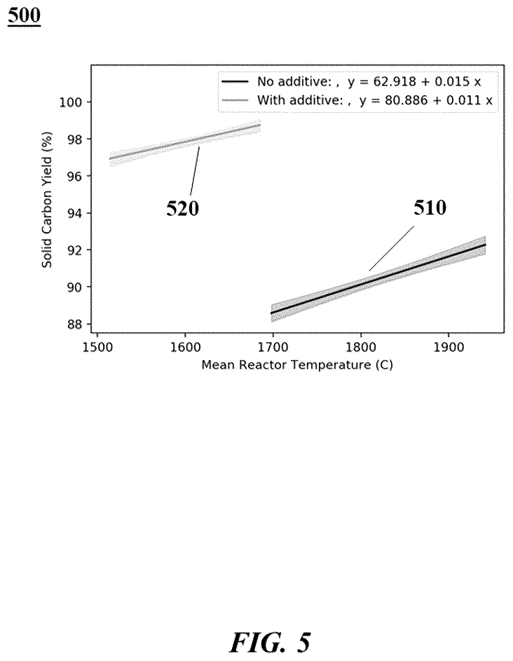

FIG. 5 is an example plot 500 of a yield of solid carbon (e.g., carbon particles) from a reactor without (510) and with (520) addition of a silicon-containing additive, according to some embodiments. Similar to FIG. 4, addition of the silicon-containing additive permits for higher yield of carbon particles at lower reaction temperatures. Such an improvement may permit use of lower reactor temperatures, which can in turn reduce costs and reactor wear. Additionally, new schemes of making carbon particles may be enabled by using lower temperatures in conjunction with silicon-containing additives. High yields of carbon particles can be an improvement of using silicon-containing additives.

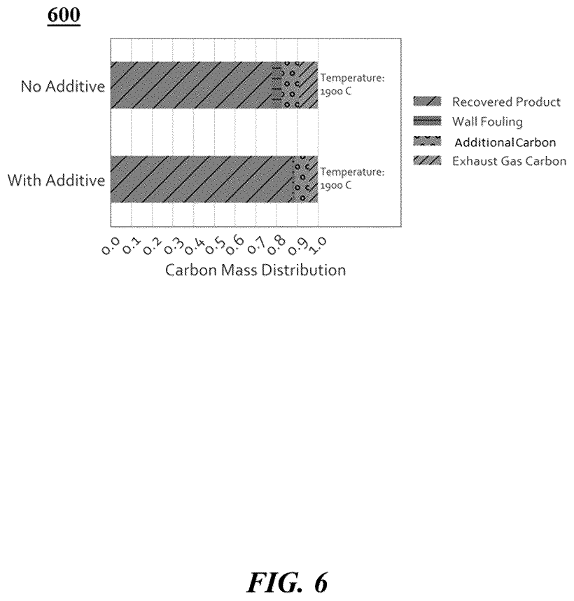

FIG. 6 shows an example of a comparison plot 600 between the products of a carbon particle generating reaction with and without addition of a silicon containing additive, according to some embodiments. As noted elsewhere, the overall yield of carbon particles (e.g., recovered product) may be higher when a silicon containing additive is used than without given similar reaction conditions (e.g., 1900 degrees Celsius for the additive free reaction and 1900 degrees Celsius for the additive reaction). Further, the total amount of fouling produced by the reaction can be significantly decreased by addition of the silicon-containing additive. The reduction of fouling may be another advantage of using a silicon-containing additive in the production of carbon particles, which can significantly improve the functioning and stability of a reactor. Reducing wall fouling may be an important part of scaling a process, and the use of a silicon-containing additive can provide such a reduction. Additionally, the amount of recovered product increasing can improve the economics of the production of the carbon particles, as more of the carbon introduced into the system can be formed into the carbon particle product. The plot 600 may be of the form of which the carbon can be removed from the reactor (e.g., recovered product can be the carbon removed as carbon particles, wall fouling can be solid carbon collected from the walls of the reactor, additional carbon may be solid carbon collected during a carbon particle generating process, and exhaust carbon can be the carbon that exits the reactor in the gas phase). The values of the plot may be normalized by the total amount of carbon introduced to the system.

A reactor used to generate the above data plots may comprise a water-cooled vessel about 2 meters in height with heating power provided by a three-phase plasma torch. Gas (e.g., thermal transfer gas) may be introduced through the torch at a rate of about 28 Nm³/h with a substantially simultaneous injection of methane at a rate of 4 Nm³/h downstream from the torch (e.g., at a feedstock dilution of 7). To provide the energy for the carbon particle generating reaction, about 70 kW of power can be supplied through the torch to heat the gas. The gas can be quenched by inert gas injection to cool the gas and convey the as formed carbon particles.

Table 1 shows additional test conditions of an example comparison reaction (e.g., the comparison reaction used to generate the data of FIG. 6). The reactor can have a plasma gas (e.g., thermal transfer gas) flow path and a feedstock (e.g., carbonaceous material) flow path. The plasma gas may not comprise carbon and may be heated using a plasma torch to a temperature of at least about 2000° C. The feedstock gas may comprise methane and a silicon-containing additive, and may be heated to at least about 400° C. to vaporize the silicon-containing additive. The feedstock gas may be then be injected into the plasma gas, and the mixture may travel to a reaction chamber. In the reaction chamber, the feedstock may decompose and form solid carbon and hydrogen, and may also produce other hydrocarbon species. Residual gas phase carbon may be a part of the residual carbon of Table 1. The temperature of Table 1 may be measured at a wall of the reaction chamber. The dilution may be a mole ratio of plasma gas to carbon in the reactor. The residual carbon may comprise the gas phase carbon mass at an exit of the reactor as a percentage of the carbon mass injected into the reactor.

TABLE 1

| | | | Carbon | | Residual |
|---|---|---|---|---|---|
| | | Si/C | Production | | Carbon |
| Temperature | Test Length | Loading | Rate | | (% of |
| (° C.) | (minutes) | (ppm) | (kg/hr) | Dilution | injected) |
| 1900 | 80 mins | 0 | 2 | 7:1 | 10.0% |
| 1900 | 75 mins | 1000 | 2 | 7:1 | 2.5% |

### Example 2—Reactor Parameters Using a Silicon-Containing Additive

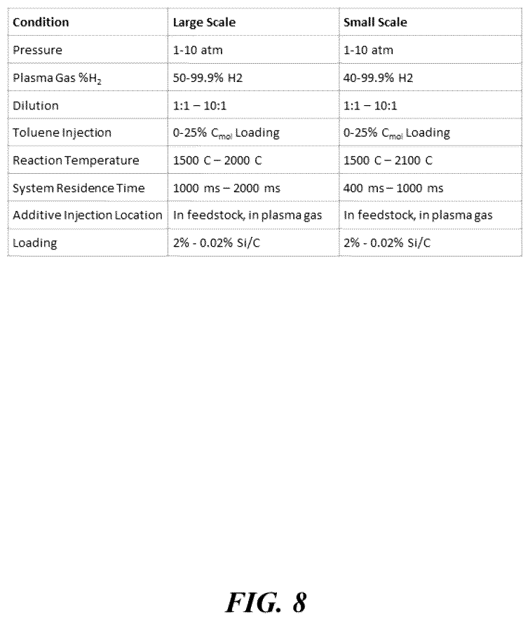

FIG. 8 shows an array of conditions for an example large and small scale reactor, according to some embodiments. In some cases, the values usable for a large scale reactor and a small scale reactor can be the same. In some cases, the differing properties of a large and small scale reactor can cause different values for a same property. The reactions may be performed in an absence of oxygen.

The pressure can be the pressure of the reactor at, for example, the plasma torch, the throat, the reactor region, or any combination thereof. The plasma gas % H₂ can be the percentage of the plasma gas that is hydrogen. The balance of the plasma gas can be as described elsewhere herein (e.g., carbonaceous material, silicon-containing additive, other thermal transfer gas, etc.). The dilution may be an amount of thermal transfer gas (e.g., hydrogen) in a feed divided by the amount of carbonaceous feedstock in a mole ratio. For example, a dilution of 6:1 can be 6 moles of hydrogen and 6 moles of carbon. The toluene injection may be a quench of toluene injected after reacting the carbonaceous product to halt the reaction. The toluene injection may be a percentage of the carbon loading by mole (Cₘₒₗ) as shown. The toluene injection may be co-injected with the carbonaceous feedstock and silicon-containing additive. Co-injecting the toluene may provide a faster start to nucleation (e.g., due to the toluene being further on the reaction pathway to polycyclic aromatic hydrocarbons. Other mono- or polycyclic aromatic hydrocarbons may be used similarly (e.g., xylenes, benzene, naphthalene, anthracene, methyl naphthalene, coronene, benzopyrene, etc.). The reaction temperature may be a temperature of the reaction in the reactor portion of the reactor. The reaction temperature may be lower than the plasma temperature (e.g., due to mixing lower temperature feedstocks with the thermal transfer gas). The reaction temperature may be determined as described elsewhere herein. For example, the reaction temperature may be a calculated reaction temperature. The system residence time may refer to the amount of time that a carbonaceous material spends in the system before being removed as a carbon particle. For example, a system with a residence time of 1500 milliseconds (ms) can have a carbonaceous material leave the reactor as a part of a carbon particle on average 1500 ms after injection into the reactor. The additive injection location may be locations where an additive (e.g., a silicon-containing additive) can be injected into the reactor. In feedstock May refer to adding the additive to the carbonaceous material prior to injecting the mixed additive and carbonaceous material into the reactor. In plasma gas may refer to adding the additive to the thermal transfer gas prior to passing the gas through a plasma torch. The loading can be the level of loading of the silicon-containing additive as a percent of the loading of carbon (e.g., % Si/C). The injection of the silicon-containing additive may be downstream of the hydrocarbon injection. For example, the silicon-containing additive can be injected into the reactor after the hydrocarbon is injected into the reactor. When the silicon-containing additive is injected downstream of the hydrocarbon, the surface area (e.g., the N2SA) of the resultant carbon particles can be increased. The increase may be at least about 1, 2, 3, 4, 5, 6, 7, 8, 9, 10, or more percent as compared to a carbon particle produced without the silicon-containing additive. When the silicon containing additive and the hydrocarbon are injected in a same part of the reactor, the surface area may be the same or substantially the same as if no silicon-containing additive were injected. For example, the surface area may be within about 5, 4, 3, 2, 1, or less percent.

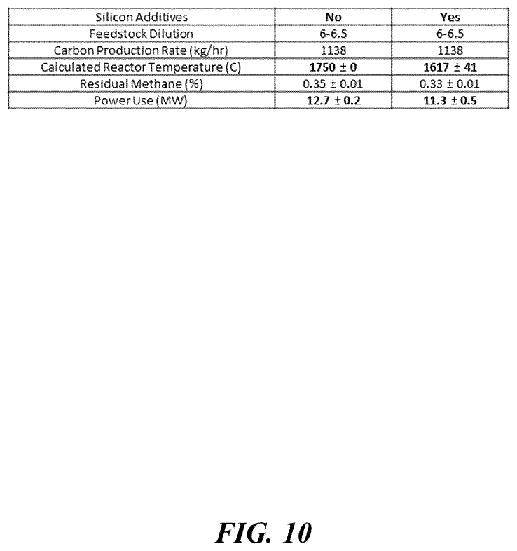

In another example, the use of a silicon-containing additive can be tested in a commercial scale plasma pyrolysis reactor. In such reactors, conversion of feedstock to carbon particles may be a key performance parameter, and the conversion can be increased by increasing reactor temperature. Use of a silicon-containing additive can enable a reactor to effect the same hydrocarbon conversion at a lower temperature, thereby providing a lower power consumption point and improved cost and environmental effectiveness. FIG. 10 provides an example of carbon particle production with and without a silicon-containing additive, according to some embodiments. The use of the silicon-containing additive can provide a significant reduction in the amount of power the production of the carbon particles takes (e.g., a savings of about 1.2 megawatt hours per ton of carbon particles produced). The carbon production rate may be a carbonaceous feedstock (e.g., natural gas) feed rate multiplied by a factor of 0.75 to account for all solid carbon that been injected into the system. Such a multiplier may be lower than an achieved production rate.

In another example, the carbon particle produced by the method and systems described elsewhere herein can be ashed (e.g., under ambient atmosphere via ASTM D1506). A comparison between the ashed particles produced with an addition of a silicon-containing additive (e.g., 500 ppm of hexamethyldisiloxane co-injected with a carbonaceous material) and the ashed particles produced without addition of a silicon-containing additive can be performed. The ashed particles which were produced without the additive may comprise an N₂SA surface area (e.g., measured by ASTM D6556) of 39.8 m²/g, have a majority elemental composition of alumina, iron oxide, and calcium oxide, and a pour density (e.g., as measured by ASTM D1513) of 324 kg/m³. The ashed particles that were produced with the silicon-containing additive can have an N₂SA of 742.7 m²/g, have a majority elemental composition of silica, and a pour density of 145 kg/m³. The process comprising the addition of the silicon-containing additive can reduce the amount of electricity used to produce the carbon particles by about 1.2 megawatt hours/ton of carbon particles produced given a production rate of 1138 kg/hr of carbon particles. A second sample produced in a process comprising addition of a silicon-containing additive may have an ashed N₂SA of 367.2 m²/g. The presence of a high surface area of the ashed product may be due to the integral formation of the carbon particle with the silicon-containing additive. For example, the co-formation of the carbon particles can generate a particle that, when ashed, provides a high surface area (e.g., since the carbon and silicon are integrally mixed).

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations, or equivalents. It is intended that the following claims define the scope of the invention and that methods and structures within the scope of these claims and their equivalents be covered thereby.

1. A method for generating a carbon particle comprising:
(a) providing a silicon-containing additive and a carbonaceous material to a reactor, wherein the silicon-containing additive is provided to the reactor at a weight ratio of the silicon-containing additive to the carbonaceous material of less than or equal to about 0.1; and
(b) in the reactor, contacting the carbonaceous material with the silicon-containing additive to generate the carbon particle.

2. The method of claim 1, wherein the carbon particle comprises at least one silicon core decorated with carbon.

3. The method of claim 1, wherein, in (a), the ratio of the silicon-containing additive to the carbonaceous material is less than or equal to about 0.01 by weight.

4. The method of claim 3, wherein, in (a), the ratio of the silicon-containing additive to the carbonaceous material is less than or equal to about 0.001 by weight.

5. The method of claim 1, wherein (b) comprises reacting the carbonaceous material with the silicon-containing additive to generate a plurality of carbon particles.

6. The method of claim 5, wherein, after (b), less than or equal to about 5% by weight of the carbonaceous material provided to the reactor is present in the reactor as wall fouling.

7. The method of claim 5, wherein a ratio of the silicon-containing additive to the carbonaceous material within the plurality of carbon particles is substantially the same as a ratio of the silicon-containing additive to the carbonaceous material within a wall fouling of the reactor.

8. The method of claim 5, wherein more than about 90% of the carbonaceous material is converted into the plurality of carbon particles on a weight percent carbon basis.

9. The method of claim 1, wherein (b) comprises (i) heating a thermal transfer gas and (ii) contacting the thermal transfer gas with the carbonaceous material and the silicon-containing additive to generate the carbon particle.

10. The method of claim 1, wherein the silicon-containing additive comprises one or more of a siloxane, a polysiloxane, a silane, and a silica.

11. The method of claim 10, wherein the silicon-containing additive comprises the siloxane, and the siloxane is hexamethyldisiloxane (HMDSO) or decamethylcyclopentasiloxane (D5).

12. The method of claim 1, wherein the silicon-containing additive comprises one or more particles.

13. The method of claim 12, wherein the silicon-containing additive comprises one or more nanoparticles.

14. The method of claim 1, wherein the carbonaceous material comprises at least about 70% by weight of methane, ethane, propane, or a combination thereof.

15. The method of claim 1, wherein the carbonaceous material comprises one or more linear hydrocarbon(s), one or more aromatic hydrocarbon(s), one or more unsaturated hydrocarbon(s), one or more oxygenated hydrocarbon(s), or any combination thereof.

16. The method of claim 1, wherein the carbonaceous material comprises methane, ethane, propane, butane, benzene, toluene, xylene, methyl naphthalene, pyrolysis fuel oil, coal tar, coal, heavy oil, oil, bio-oil, bio-diesel, other biologically derived hydrocarbons, ethylene, acetylene, butadiene, styrene, ethanol, methanol, propanol, phenol, ketones, ethers, esters, or any combination thereof.

17. The method of claim 1, further comprising reacting the carbonaceous material with the silicon-containing additive in a presence of a plasma.

18. The method of claim 1, wherein, in (b), the contacting is to generate the carbon particle at a rate of at least about 600 kilograms/hour (kg/h) of carbon particle production.

19. The method of claim 1, wherein an energy used to produce the carbon particle is reduced by at least about 5% as compared to a method without addition of the silicon-containing additive.

20.-65. (canceled)

66. A carbon particle comprising a structure, wherein an ash comprising the structure produced from the carbon particle via ASTM D1506 has a surface area of at least about 100 square meters per gram (m²/g).

67. (canceled)

68. The carbon particle of claim 66, wherein the carbon particle is carbon black.

69. The carbon particle of claim 66, wherein the structure comprises silicon.

70.-89. (canceled)
